(19) United States
(12) Patent Application Publication
(10) Pub. No.: US 2014/0220404 A1
(43) Pub. Date: Aug. 7, 2014

(54) BATTERY ASSEMBLY

(71) Applicants: Yukiko Yoshioka, (US); Noritaka Yoshioka, (US); Miki Yoshioka, (US); Lithium Energy Japan, Kyoto-shi, Kyoto (JP)

(72) Inventors: Yoshihiro Masuda, Ritto-shi (JP); Toshiki Yoshioka, Ritto-shi (JP)

(21) Appl. No.: 14/126,825

(22) PCT Filed: Jun. 18, 2012
(86) PCT No.: PCT/JP2012/065491

§ 371 Date: Apr. 21, 2014

(30) Foreign Application Priority Data
Jun. 17, 2011 (JP) 2011-135428

(51) Int. Cl. H01M 10/6557

(52) U.S. Cl. CPC H01M 10/5059
USPC 429/120

(57) ABSTRACT

A spacer interposed between first and second unit cells has alternately arranged first and second corrugated portions. Each of the corrugated portions has first and second protrusions alternately and repeatedly formed continuously in a vertical direction. Each of the first protrusions protrudes from a center in a thickness direction toward the first unit cell so as to define a clearance functioning as a cooling passage between the second unit cell and the first protrusion. Each of the second protrusions protrudes from the center in the thickness direction toward the second unit cell so as to define a clearance functioning as a cooling passage between the first unit cell and the second protrusion. The arrangement phases of the first and second protrusions are different from each other in the first and second corrugated portions. A cooling medium flowing in the cooling passages is alternately brought into contact with the first and second unit cells, thus achieving the uniform cooling efficiency with respect to the unit cells.

### TECHNICAL FIELD

The present invention relates to a battery assembly having a plurality of unit cells combined with each other and, more particularly, to the structure of a spacer held between unit cells.

### BACKGROUND ART

There has been conventionally known a structure in which a spacer is held between unit cells in a battery assembly so as to form a cooling passage, through which a cooling medium passes, so that the cooling medium passing the cooling passage cools the unit cells that generate heat by repeated electric charging/discharging.

Patent literature 1 discloses a spacer held between battery modules. In the spacer, first abutting portions that abut against a first battery module out of two adjacent battery modules and second abutting portions that abut against a second battery module are alternately disposed, and thus, cooling passages in which the first battery module is brought into contact with a cooling medium and other cooling passages in which the second battery module is brought into contact with the cooling medium are alternately formed. Moreover, the spacer is provided with walls for preventing the cooling passages from being narrowed when the battery modules expand between the first abutting portion and the second abutting portion.

Patent literature 2 discloses a corrugated spacer held between battery modules, wherein cooling passages are defined by clearances between the spacer and the battery modules.

Patent literature 3 discloses disposing a spacer having cooling passages formed thereat between secondary batteries and interposing a corrugated plate between the secondary batteries. In particular, Patent literature 3 discloses a spacer in which structures, each having a lateral bar and a vertical wall combined with each other, define two kinds of cooling passages alternately arranged.

Patent literature 4 discloses a cell holder (i.e., a spacer) in which recesses and projections linearly extending at a surface opposite to a storage cell are alternately arranged, wherein a cooling passage is defined in a clearance defined between the recess and the storage cell.

Patent literature 5 discloses a battery holder (i.e., a spacer) in which grooves are formed at both surfaces of a base wall, and then, a cooling passage is formed from a slit at a support frame at one end of the base wall to a slit at a support frame at the other end through the grooves.

Patent literature 6 discloses an uneven spacer having projections and grooves alternately arranged, wherein a cooling medium is allowed to pass through the grooves.

However, with respect to the spacers disclosed in Patent literatures 1 to 6, the cooling medium passing each of the plurality of cooling passages formed by the spacer is brought into contact with only either one of the adjacent unit cells but in separation from the other one. In other words, the cooling medium passing each of the cooling passages cools only either one of the adjacent unit cells but does not cool both of them. Consequently, in the case where the adjacent unit cells generate the different amounts of heat, a difference in cooling efficiency arises between the cooling medium in contact with the unit cell for generating more heat and the cooling medium in contact with the unit cell for generating less heat, thereby inhibiting efficient cooling.

### CITATION LIST

### Patent Literature

Patent literature 1: JP 2006-073461 A (paragraphs 0025 to 0027 and FIG. 2)
Patent literature 2: JP 2004-031364 A (paragraph 0056 and FIG. 5)
Patent literature 3: JP 2004-047426 A (paragraphs 0035 to 0041 and FIG. 7)
Patent literature 4: JP 2010-140802 A (paragraphs 0028 and 0029 and FIG. 2)
Patent literature 5: JP 2010-186681 A (paragraphs 0017 and 0018 and FIG. 2)
Patent literature 6: JP 2010-015949 A (paragraph 0022)

### SUMMARY OT INVENTION

### Technical Problem

An object of the present invention is to provide a battery assembly provided with a spacer for forming a cooling passage capable of efficiently cooling both of adjacent unit cells.

### Solution to Problem

The present invention provides a battery assembly comprising, a first unit cell and a second unit cell disposed adjacently to each other; and a spacer interposed between the first unit cell and the second unit cell and adapted to form a cooling passage, through which a cooling medium is allowed to pass, wherein the spacer comprises, a first corrugated portion having first protrusions and second protrusions alternately and repeatedly formed in a direction crossing the cooling passage, wherein each of the first protrusion protrudes toward the first unit cell from a center in a thickness direction so as to define a clearance functioning as the cooling passage between the second unit cell and the first protrusion whereas each of the second protrusion protrudes toward the second unit cell from the center in the thickness direction so as to define a clearance functioning as the cooling passage between the first unit cell and the second protrusion, and a second corrugated portion arranged adjacently to the first corrugated portion in the direction of the cooling passage and having the first and second protrusions alternately and repeatedly formed in the direction crossing the cooling passage at a phase different from that of the first corrugated portion.

The arrangement phases of the first and second protrusions are different from each other in the first and second corrugated portions disposed adjacently to each other. Therefore, the cooling medium passing through the clearance between the first protrusions in the first corrugated portion and the second unit cell subsequently passes through the clearance between the second protrusions in the second corrugated portion and the first unit cell. Moreover, the cooling medium passing through the clearance between the second protrusions in the first corrugated portion and the first unit cell subsequently passes through the clearance between the first protrusions in the second corrugated portion and the second cell. That is to say, the cooling medium flowing in the cooling passage is alternately brought into contact with the first unit cell and the second unit cell that are disposed adjacently to each other. In other words, the flow of the same cooling medium is brought into contact with the first unit cell and the second unit cell that are disposed adjacently to each other. As a consequence, the cooling medium can cool the adjacent first and second unit cells with the uniform cooling efficiency, thus reducing a difference in temperature between the first and second unit cells. Particularly, even in the case where the adjacent first and second unit cells generate heat in the different amounts, the uniform cooling efficiency between the unit cells enables both of the unit cells to be efficiently cooled.

The cooling medium flowing in the cooling passage is alternately brought into contact with the first unit cell and the second unit cell that are disposed adjacently to each other. That is to say, the cooling medium does not flow in the cooling passage on a substantially linear channel but flows toward the second unit cell in the different direction due to the contact with or collision against the first unit cell, and further, flows toward the first unit cell in the different direction due to the contact with or collision against the second unit cell. In other words, the contact with or collision against the first and second unit cells is repeated while the cooling medium flows in the cooling passages on the corrugated channels. Consequently, the flow of the cooling medium in the cooling passages is not laminar or the like but turbulent or the like. The cooling medium flowing in the cooling passages in the turbulent state can efficiently cool the first and second unit cells.

The cooling medium flows in the clearance defined between the first protrusions protruding toward the first unit cell and the second unit cell and the clearance defined between the second protrusions protruding toward the second unit cell and the first unit cell. Here, these clearances function as the cooling passages. Consequently, it is possible to secure the clearances having a cross-sectional area required for functioning as the cooling passages between the first and second unit cells and the spacer while thinning the spacer.

Specifically, the first protrusions abut against the first unit cell whereas the second protrusions abut against the second unit cell.

The respective first protrusions of the first corrugated portion and the respective second protrusions of the second corrugated portion are aligned in the direction of the cooling passage; and the respective second protrusions of the first corrugated portion and the respective first protrusions of the second corrugated portion are aligned in the direction of the cooling passage.

Furthermore, the first and second corrugated portions are alternately arranged in the direction of the cooling passage.

With this configuration, the cooling medium flowing in the cooling passage alternately repeats the contact with or collision against the first unit cell and the contact with or collision against the second unit cell. The turbulence of the cooling medium flowing in the cooling passage is promoted with every contact with or collision against the first or second unit cell, thus enhancing the cooling efficiency of the cooling medium with respect to the first and second unit cells.

The spacer has a slit extending in the direction crossing the cooling passage, and the first corrugated portion and the second corrugated portion are formed upstream and downstream of the cooling passage in the slit.

The formation of the slit enables the cooling medium flowing from the first corrugated portion to the second corrugated portion to be agitated in the direction crossing the cooling passage. This agitation promotes the turbulence of the cooling medium, thus further enhancing the cooling efficiency with respect to the first and second unit cells.

The spacer further includes a connecting portion extending in the direction crossing the cooling passage.

The spacer further includes a first bar at one end in the direction crossing the cooling passages in the first and second corrugated portions as well as a second bar at the other end; and the connecting portion connects the first bar and the second bar to each other.

The formation of the connecting portion can reinforce the rigidity in the direction perpendicular to the direction of the cooling passage at the first and second corrugated portions. Even if the spacer receives a compressing force from the first and second unit cells owing to the expansion of the unit cells, it is possible to prevent the first and second corrugated portions from extending in the direction perpendicular to the direction of the cooling passages so as to prevent the clearances between the first and second unit cells from being narrowed. Since the clearance between the first and second unit cells can be maintained, the cross-sectional area of the cooling passage can be secured, and thus, the cooling efficiency can be maintained.

At least either one of the upstream end and the downstream end of the cooling passage defined by the first and second protrusions should be preferably chamfered at a corner portion. With this configuration, the cooling medium can smoothly pass the first and second protrusions without any pressure drop.

### Advantageous Effects of Invention

The spacer provided in the battery assembly according to the present invention includes the first and second corrugated portions. The first and second protrusions are arranged at the different phases in these corrugated portions. With this configuration, it is possible to secure the clearances having cross-sectional areas required for functioning as the cooling passages between the unit cells and the spacer while thinning the spacer. Moreover, the uniform cooling efficiency between the unit cells can efficiently cool the unit cells. Additionally, the cooling medium flowing in the cooling passages in the turbulent state or the like can efficiently cool the first and second unit cells.

### BRIEF DESCRIPTION OF THE DRAWINGS

FIG. 1 is a perspective view showing a battery assembly according to the present invention;

FIG. 2 is a perspective view showing a spacer for the battery assembly shown in FIG. 1;

FIG. 3 is a front view showing the spacer for the battery assembly shown in FIG. 1;

FIG. 4 is a cross-sectional view showing the spacer shown in FIG. 2, taken along a line IV-IV;

FIG. 5 is a cross-sectional view showing the spacer shown in FIG. 2, taken along a line V-V;

FIG. 6 is a perspective view showing a flow of a cooling medium in the battery assembly shown in FIG. 1;

FIG. 7(a) is a cross-sectional view showing the spacer shown in FIG. 2, taken along a line VIIa-VIIa;

FIG. 7(b) is a cross-sectional view showing the spacer shown in FIG. 2, taken along a line VIIb-VIIb;

FIG. 8(a) is a perspective view showing another preferred embodiment of a spacer;

FIG. 8(b) is a cross-sectional view taken along a line VIIIb-VIIIb;

FIG. 9(a) is a perspective view showing a further preferred embodiment of a spacer;

FIG. 9(b) is a cross-sectional view taken along a line IXb-IXb;

FIG. 10(a) is a perspective view showing a still further preferred embodiment of a spacer; and

FIG. 10(b) is a cross-sectional view taken along a line Xb-Xb.

### DESCRIPTION OF EMBODIMENTS

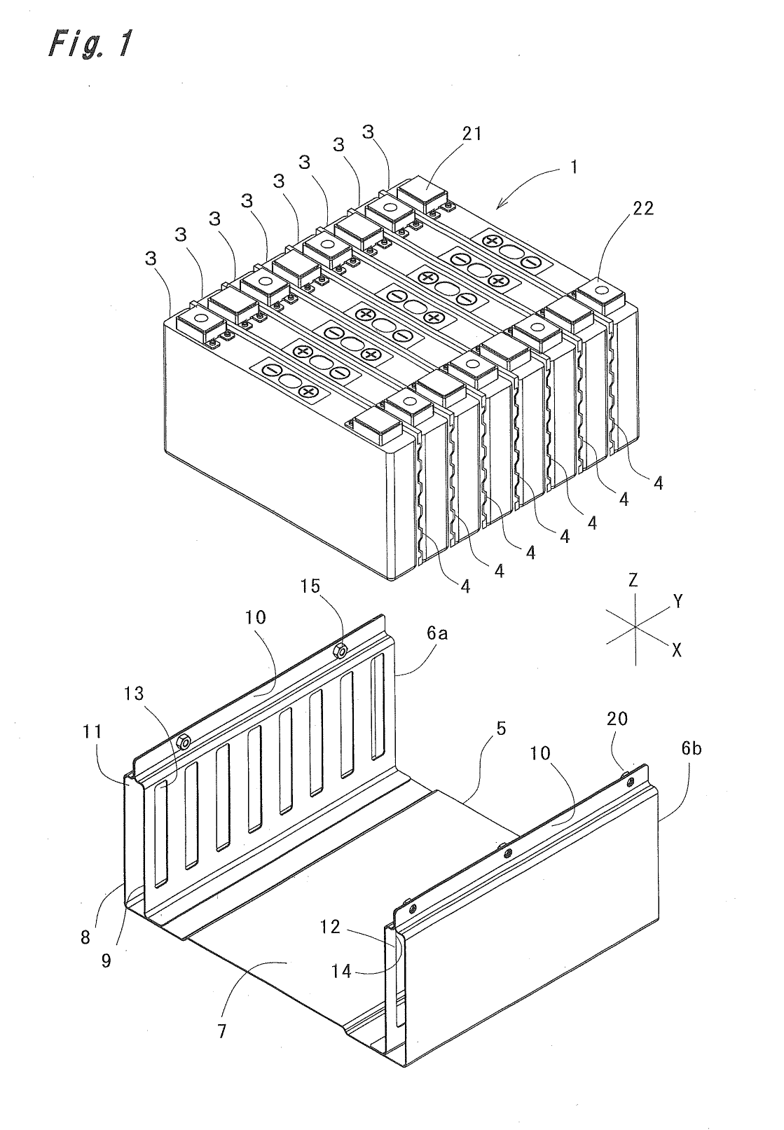

Preferred embodiments according to the present invention will be described with reference to the attached drawings. In the present specification, an X-axis and a Y-axis are set perpendicularly to each other on a horizontal plane whereas a Z-axis is set on a vertical plane perpendicular to the X- and Y-axes for the sake of explanation, as shown in FIG. 1. Directions parallel to the X-, Y-, and Z-axes are referred to as an X-direction, a Y-direction, and a Z-direction, respectively.

FIG. 1 shows a battery assembly 1 according to a preferred embodiment of the present invention. In the battery assembly 1, a plurality of unit cells 3 are juxtaposed in a stack case 2, and further, spacers 4 are held between the unit cells 3.

The stack case 2 is made of a steel plate. The stack case 2 includes a rectangular bottom plate 5 extending in the X- and Y-directions and a left wall 6a and a right wall 6b erected in the Z-direction at both ends in the X-direction of the bottom plate 5. The stack case 2 is opened at both ends in the Y-direction and at an upper end in the Z-direction.

The bottom plate 5 includes a battery mount 7 that is slightly higher at the center thereof than at both ends in the X-direction.

Each of the left wall 6a and the right wall 6b is formed of an outer wall 8 and an inner wall 9. The lower end of the outer wall 8 is formed integrally with the bottom plate 5 in such a manner as to be continuous to the end of the bottom plate 5 in the X-direction. The lower end of the inner wall 9 is joined to the bottom plate 5. Respective upper ends 10 of the outer wall 8 and the inner wall 9 are bent in an L shape toward each other, followed by joining to each other.

A space defined between the outer wall 8 and the inner wall 9 on the left wall 6a forms a first refrigerant passage 11. In the same manner, a space defined between the outer wall 8 and the inner wall 9 on the right wall 6b forms a second refrigerant passage 12.

A plurality of first openings 13 communicating with the first refrigerant passage 11 are formed on the inner wall 9 on the left wall 6a at the same predetermined intervals in the Y-direction as the arrangement intervals of the spacers 4. A plurality of second openings 14 similar to the first openings 13 formed on the left wall 6a are formed also on the inner wall 9 on the right wall 6b.

To the upper ends 10 and 10 of the walls 6a and 6b are securely fixed nuts 15 for fixing a cover, not shown.

The unit cell 3 is a non-aqueous secondary battery such as a lithium-ion battery. The unit cell 3 has a width in the X-direction, a depth in the Y-direction, and a height in the Z-direction such that it can be held between the left wall 6a and the right wall 6b of the stack case 2. The unit cell 3 has a positive electrode 21 and a negative electrode 22 at the upper surface thereof. The positive electrodes 21 and the negative electrodes 22 in the unit cells 3 adjacent to each other in the Y-direction are connected to each other via bus bars, not shown. The unit cell 3 may be constituted of a literally single cell or may be constituted of a unit consisting of a plurality of small cells arranged in the X-direction.

The spacer 4 is made of a synthetic resin. The spacer 4 includes an upper bar 23 to a lower bar 24 that extend in the X-direction. Corrugated portions 25 are held between the upper bar 23 and the lower bar 24. The corrugated portion 25 includes a first slit 26 extending from the upper bar 23 and the lower bar 24 in the Z-direction and a second slit 27 narrower in width than the first slit. The three first slits 26 are formed at the center and both ends in the X-direction, respectively. The ten second slits 27 in total are formed: four second slits 27 are formed between the center first slit 26 and the left first slit 26 in the drawings; four second slits 27 are formed between the center first slit 26 and the right first slit 26 in the drawings; one second slit 27 is formed between the left first slit 26 and the left end of the corrugated portion 25; and one second slit 27 is formed between the right first slit 26 and the right end of the corrugated portion 25. A straight portion (i.e., a connecting portion) 28 for connecting the upper edge of the slit 26, that is, the upper bar 23 and the lower edge, that is, the lower bar 24 to each other is formed inside of each of the first slits 26 in such a manner as to extend straight in the Z-direction. The first slit 26, the second slit 27, and the straight portion 28 may extend in directions other than the Z-direction as long as they extend in directions crossing cooling passages 31 and 32, described later.

As for the size of the spacer 4, a width in the X-direction is determined as being the same as or smaller than that of the unit cell 3, and further, a height in the Z-direction is determined as being the same as or greater or smaller than that of the unit cell 3. The dimension in the Y-direction, that is, the thickness of the spacer 4 determines the interval between the adjacent unit cells 3 in the Y-direction. The dimension in the Z-direction, that is, the height of each of the upper bar 23 and the lower bar 24 of the spacer 4 should be preferably as small as possible in order to widen the corrugated portion 25 as possible so as to secure the cooling passages 31 and 32, described later.

The corrugated portion 25 in the spacer 4 includes a first corrugated portion 25a and a second corrugated portion 25b positioned on both sides while holding the second slit 27 therebetween, that is, upstream and downstream of the cooling passages 31 and 32, described later, respectively. The second corrugated portions 25b are disposed on both sides while holding the first slit 26 therebetween.

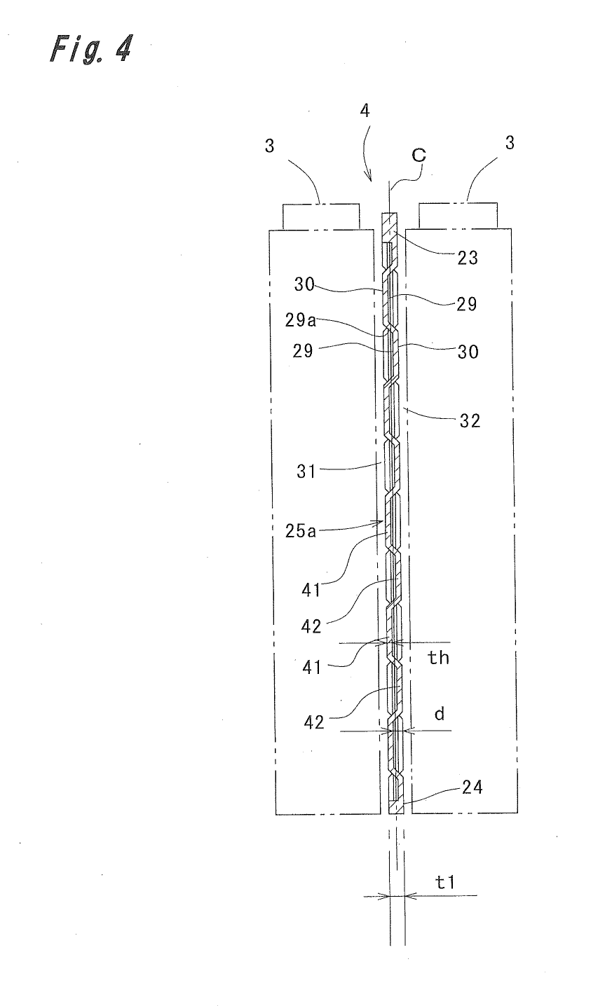

Referring to FIG. 4, the first corrugated portion 25a is provided with first protrusions 41 and second protrusions 42 that are alternately repeated in a manner continuous to each other in the Z-direction (i.e., a direction perpendicular to the cooling passages 31 and 32, described later). The first protrusion 41 protrudes toward the left unit cell 3, as viewed in the X-direction with respect to the center C in the thickness direction of the spacer 4. A clearance defined between the first protrusion 41 and the right unit cell 3, as viewed in the X-direction, functions as a cooling passage 30. The second protrusion 42 protrudes toward the right unit cell 3, as viewed in the X-direction with respect to the center C in the thickness direction of the spacer 4. A clearance defined between the second protrusion 42 and the left unit cell 3, as viewed in the X-direction, functions as the cooling passage 31. As most clearly shown in FIG. 4, the first and second protrusions 41 and 42 are alternately repeated in the manner continuous to each other, and therefore, the first corrugated portion 25 is formed into a zigzag or meander, as viewed in the X-direction.

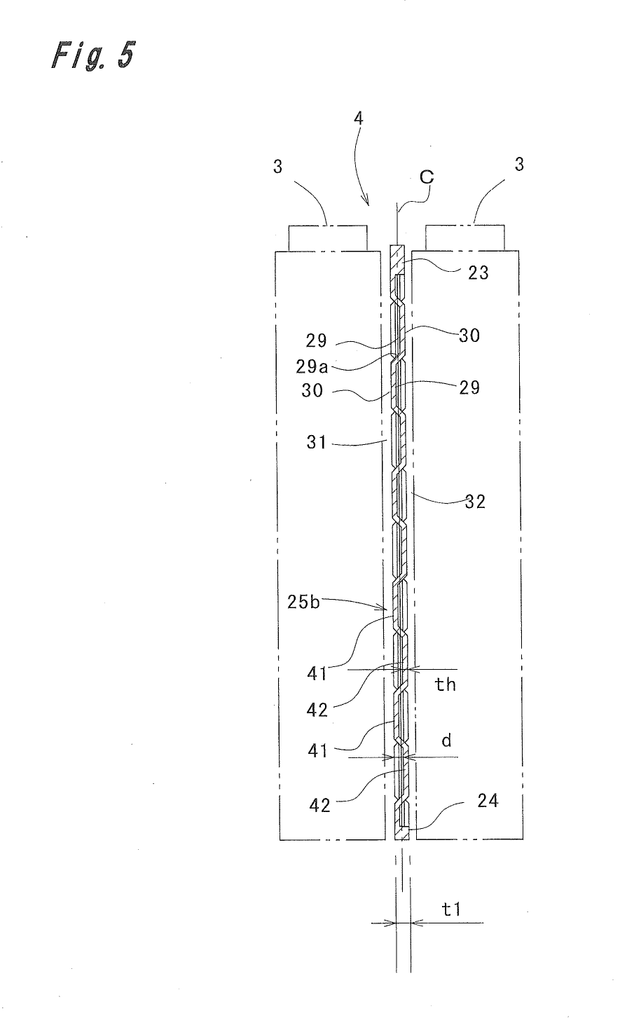

Referring to FIG. 5, in the same manner as the first corrugated portion 25a, the second corrugated portion 25b is provided with first and second protrusions 41 and 42 that are alternately repeated in a manner continuous to each other in the Z-direction. A clearance defined between the first protrusion 41 and the right unit cell 3, as viewed in the X-direction, functions as the cooling passage 32 whereas a clearance defined between the second protrusion 42 and the left unit cell 3, as viewed in the X-direction, functions as the cooling passage 31. The phase of the arrangement of the first and second protrusions 41 and 42 in the second corrugated portion 25b is opposite to that in the first corrugated portion 25a (i.e., shifted at 180°). In other words, the first protrusions 41 in the first corrugated portion 25a and the second protrusions 42 in the second corrugated portion 25b are aligned in the X-direction (i.e., the direction of the cooling passages 30 and 31). In the meantime, the second protrusions 42 in the first corrugated portion 25a and the first protrusions 41 in the second corrugated portion 25b are aligned in the X-direction (i.e., the direction of the cooling passages 31 and 32).

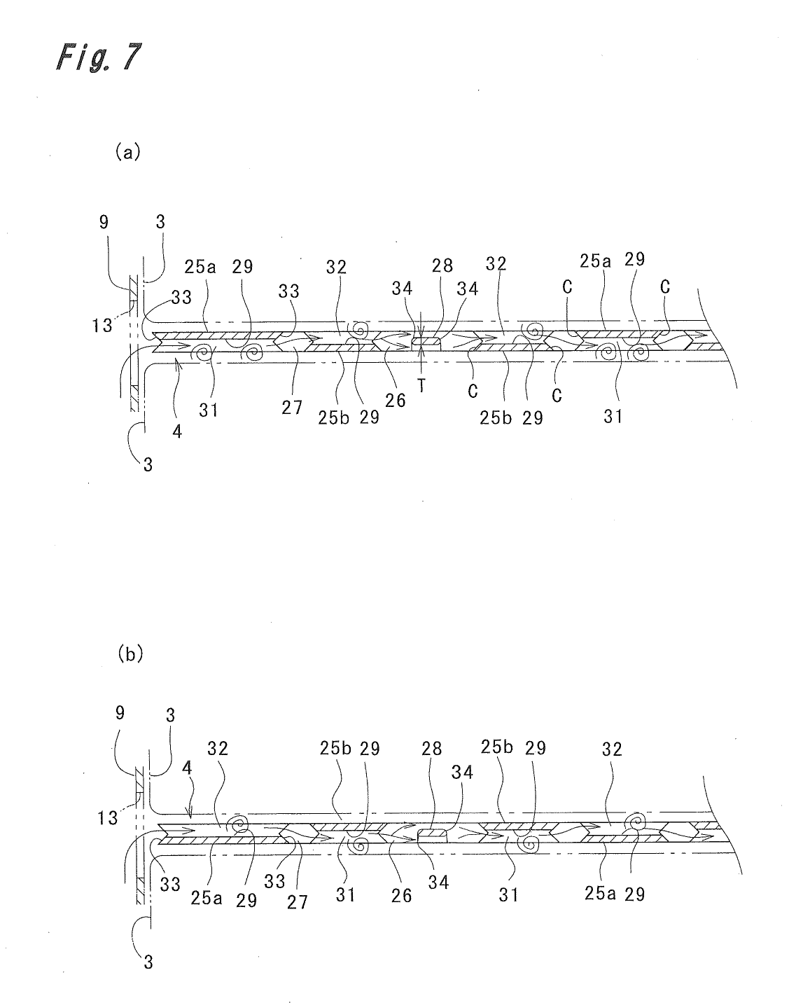

Although FIGS. 4 and 5 show the clearances between the unit cells 3 and the spacer 4 for the sake of convenience, actually, the first protrusions 41 are brought into contact with the left unit cell 3 whereas the second protrusions 42 are brought into contact with the right unit cell 3 (the same goes for FIG. 7, described later).

The first corrugated portion 25a and the second corrugated portion 25b, each having the first and second protrusions 41 and 42 alternately arranged thereat in the continuous manner, have a shape below, as viewed at only either one surface. Although a description will be given of the first corrugated portion 25a, the same goes for the second corrugated portion 25b.

In the first corrugated portion 25a, recesses 29 and projections 30, each extending in the X-direction, are alternately formed in the Z-direction at a first surface, as viewed in the Y-direction (left in FIG. 4): in contrast, recesses 29 and projections 30, each extending in the X-direction, are alternately formed in the Z-direction at the reverse of the first surface, that is, at a second surface (right in FIG. 4). Although the first corrugated portion 25a is formed into a shape obtained by the flat recesses 29 and the flat projections 30 continuous to each other via slopes 29a in the present preferred embodiment, it may be formed into a shape obtained by the flat recesses 29 and the flat projections 30 via horizontal portions or the recesses 29 and the projections 30 may be continuous to each other in a corrugated shape.

The recesses 29 at the first surface and the projections 30 at the second surface are formed into shapes complement to each other: namely, the recess 29 at the first surface forms the projection 30 at the second surface. In the same manner, the projections 30 at the first surface and the recesses 29 at the second surface are formed into shapes complement to each other: namely, the projection 30 at the first surface forms the recess 29 at the second surface. The recesses 29 at the first surface defines the cooling passage 31 of the unit cell 3 facing the first surface, and further, the projections 30 at the first surface is brought into contact with the unit cell 3 facing the second surface. In the same manner, the recess 29 at the second surface defines the cooling passage 32 of the unit cell 3 facing the second surface, and further, the projections 30 at the second surface is brought into contact with the unit cell 3 facing the first surface.

Inclined chamfers 33 (see FIG. 7) are formed at both ends in the X-direction of each of the recesses 29 in the spacer 4. This can reduce a pressure drop of a flow of a cooling medium, thus smoothing the flow of the cooling medium in the cooling passages 31 and 32.

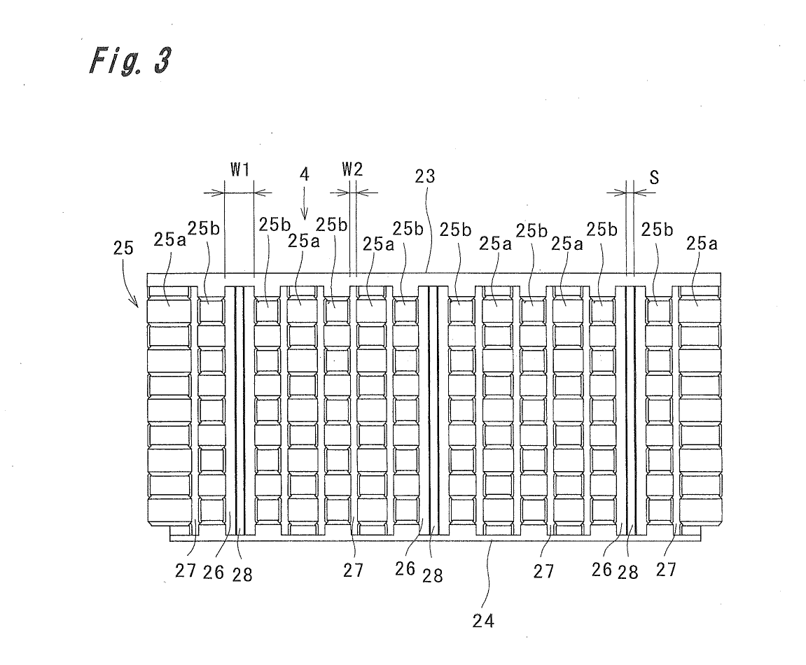

As shown in FIG. 3, a width W1 in the X-direction of the first slit 26 of the spacer 4 should be preferably as small as possible in order to keep the rigidity of the spacer 4. Moreover, although the number of first slits 26 should be preferably three like the preferred embodiment, it may be more than three, one at the center, or two at both ends.

In the same manner, as shown in FIG. 3, a width W2 in the X-direction of the second slit 27 of the spacer 4 should be preferably as small as possible in order to keep the rigidity of the spacer 4. Although the number of second slits 27 is arbitrary, it is not limited to the number in the preferred embodiment.

Although the straight portion 28 in the spacer 4 has a rectangular cross section in the present preferred embodiment, it may have a circular or elliptical cross section.

A width S (see FIG. 3) in the X-direction of the straight portion 28 in the spacer 4 may be determined in consideration of the tensile strength with respect to elongation in the Z-direction and the entire rigidity as long as it is smaller than the width W of the first slit 26. A thickness T in the Y-direction of the straight portion 28 should be preferably smaller than the depth of the recess 29 in order to reduce the passage resistance of each of the cooling passages 31 and 32, as shown in FIG. 7(a), and more preferably, should be the same as or less than the thickness in the Y-direction of the corrugated portion 25.

The straight portion 28 in the spacer 4 should be preferably located at the center of the dimension, that is, the thickness in the Y-direction of the spacer 4.

At least either one of an upstream end and a downstream end of each of the cooling passages 31 and 32 in the straight portion 28 in the spacer 4 has a round chamfer 34 at a corner portion. This can reduce a pressure drop of a flow of a cooling medium, thus smoothing the flow of the cooling medium in the cooling passages 31 and 32.

Referring to FIGS. 4 and 5, a thickness t1 of the spacer 4 is equivalent to the sum of a depth d of each of the cooling passages 31 and 32 and a thickness th of the spacer 4. The use of the corrugated portion 25 obtained by alternately repeating the first and second protrusions 41 and 42 continuously in the direction perpendicular to the cooling passages 31 and 32 can secure the clearance having a cross-sectional area required for functioning as the cooling passages 31 and 32 between the unit cells 3 and the spacer 4 while thinning the spacer 4.

Next, explanation will be made on the operation of the spacer 4, in particular, in the battery assembly 1 having the above-described configuration.

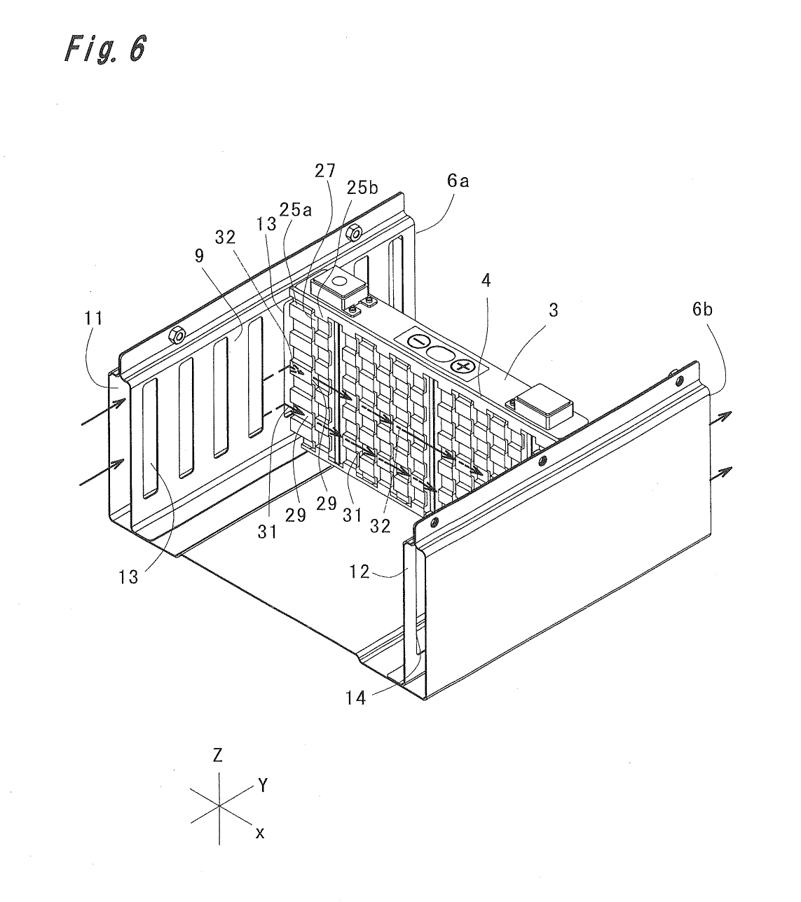

As shown in FIG. 6, a refrigerant introduced into the first refrigerant passage 11 on the left wall 6a of the stack case 2 flows from the first opening 13 of the inner wall 9 into the recesses 29 at the first and second surfaces in the spacer 4.

The refrigerant flowing from the first opening 13 into the recesses 29 (i.e., the clearance defined between the second protrusion 42 of the first corrugated portion 25a and the left unit cell 3) at the first corrugated portion 25a at the first surface of the spacer 4 flows in the X-direction along the cooling passage 31 defined by the recesses 29, thus cooling the unit cell 3 facing the first surface (i.e., the left unit cell 3). The refrigerant having passed the recesses 29 at the first corrugated portion 25a flows into the recesses 29 (i.e., the clearance defined between the first protrusion 41 of the second corrugated portion 25b and the right unit cell 3) of the second corrugated portion 25b through the second slit 27. The refrigerant flowing into the recesses 29 at the second corrugated portion 25b flows in the X-direction along the cooling passage 32 defined by the recesses 29, thus cooling the unit cell 3 facing the second surface (i.e., the right unit cell 3). The refrigerant having passed the recesses 29 at the second corrugated portion 25b flows into the recesses 29 at the second surface of the next second corrugated portion 25b through the first slit 26, and thereafter, flows into the recesses 29 at the first surface of the next first corrugated portion 25a through the second slit 27 again. In this manner, the same flow is repeated.

In the same manner, the refrigerant flowing from the first opening 13 into the recesses 29 (i.e., the clearance defined between the first protrusion 41 of the first corrugated portion 25a and the right unit cell 3) at the first corrugated portion 25a at the second surface of the spacer 4 flows in the X-direction along the cooling passage 32 defined by the recesses 29, thus cooling the unit cell 3 facing the second surface. The refrigerant having passed the recesses 29 at the first corrugated portion 25a flows into the recesses 29 (i.e., the clearance defined between the second protrusion 42 of the second corrugated portion 25b and the left unit cell 3) of the second corrugated portion 25b through the second slit 27. The refrigerant flowing into the recesses 29 at the second corrugated portion 25b flows in the X-direction along the cooling passage 32 defined by the recesses 29, thus cooling the unit cell 3 facing the first surface. The refrigerant having passed the recesses 29 at the second corrugated portion 25b flows into the recesses 29 at the first surface of the second corrugated portion 25b through the first slit 26, and thereafter, flows into the recesses 29 at the second surface of the first corrugated portion 25a through the second slit 27 again. In this manner, the same flow is repeated.

In this way, the cooling medium alternately flows in the cooling passage 31 at the first corrugated portion 25a and the cooling passage 32 at the second corrugated portion 25b, so that it can be alternately brought into contact with the unit cells 3 facing the first and second surfaces of the spacer 4. In other words, the flow of the same cooling medium is brought into contact with the two unit cells 3 arranged adjacent to each other. As a consequence, the cooling efficiency of the cooling medium can be uniformly adjusted between the two adjacent unit cells 3, thus reducing a difference in temperature between the unit cells 3. Particularly, even in the case where the two adjacent unit cells 3 generate heat in the different amounts, the uniform cooling efficiency with respect to the unit cells 3 enables both of the unit cells 3 to be efficiently cooled.

The cooling medium flowing in the cooling passages 31 and 32 is alternately brought into contact with the two unit cells 3 disposed adjacent to each other. That is to say, the cooling medium does not flow in the cooling passage via a substantially linear channel but flows toward one of the unit cells 3 in the different direction due to the contact with or collision against the other unit cell 3, and further, flows toward the other unit cell 3 in the different direction due to the contact with or collision against the one unit cell 3. In other words, the contact with or collision against the two adjacent unit cells 3 is repeated while the cooling medium flows in the cooling passages on the corrugated channels. Consequently, as conceptually shown in FIGS. 7(a) and 7(b), the flow of the cooling medium in the cooling passages is not laminar or the like but turbulent or the like. The cooling medium flowing in the cooling passages 31 and 32 in the turbulent state can efficiently cool the unit cells 3.

The corrugated portion 25 is constituted by alternately and repeatedly arranging the first corrugated portion 25a and the second corrugated portion 25b, each having the first and second protrusions 41 and 42 whose arrangement phases are opposite to each other, in the direction of the cooling passages 31 and 32. Therefore, the cooling medium flowing in the cooling passages 31 and 32 alternately repeats the contact with or collision against one of the unit cells 3 and the contact with or collision against the other unit cell 3. The turbulence of the cooling medium flowing in the cooling passages 31 and 32 is promoted with every contact with or collision against the unit cell 3, thus enhancing the cooling efficiency of the cooling medium with respect to the unit cell 3.

As described above, the first corrugated portion 25a and the second corrugated portion 25b are arranged on both sides of the second slit 27. The cooling medium flowing into the second slit 27 through the cooling passages 31 and 32 defined by the first corrugated portions 25a is agitated in the Z-direction (i.e., the direction perpendicular to the cooling passages 31 and 32), and then, the agitated refrigerant flows into the cooling passages 31 and 32 defined by the second corrugated portions 25b. This agitation promotes the turbulence of the cooling medium, thus further enhancing the cooling efficiency with respect to the unit cell 3.

As conceptually shown in FIGS. 7(a) and 7(b), the flow of the refrigerant flowing from the recesses 29 is diverted onto one side and the other side of the adjacent unit cells 3 when the refrigerant flows into the straight portion 28, and then, the flows merge with each other when the refrigerant flows from the straight portion 28. As a consequence, the flows of the refrigerant flowing onto the bottom side of the recess 29 and the cooling medium flowing near the unit cell 3 on the side of the opening of the recess 29 can be changed over, thus enhancing the cooling efficiency.

The refrigerant alternately having passed the cooling passages 31 and 32 at the first corrugated portion 25a and the second corrugated portion 25b in the spacer 4 flows into the second refrigerant passage 14 through the second opening 14 formed on the right wall 6b of the stack case 2.

The formation of the straight portion 28 can reinforce the rigidity of the corrugated portion 25 in the Z-direction. The repetition of the electric charging/discharging enables the adjacent unit cells 3 and 3 to press the spacer 4 when the unit cells 3 expand. As a consequence, although the first and second corrugated portions 25a and 25b in the spacer 4 are crushed to intend to extend in the Z-direction, the straight portion 28 tenses to prevent the extension. Since the extension of the corrugated portion 25 in the spacer 4 can be prevented, the interval between the adjacent unit cells 3 can be constantly kept, and therefore, the distance between the adjacent battery packs 3 cannot be narrowed, thus maintaining the cooling efficiency.

The above-described preferred embodiment may be variously modified.

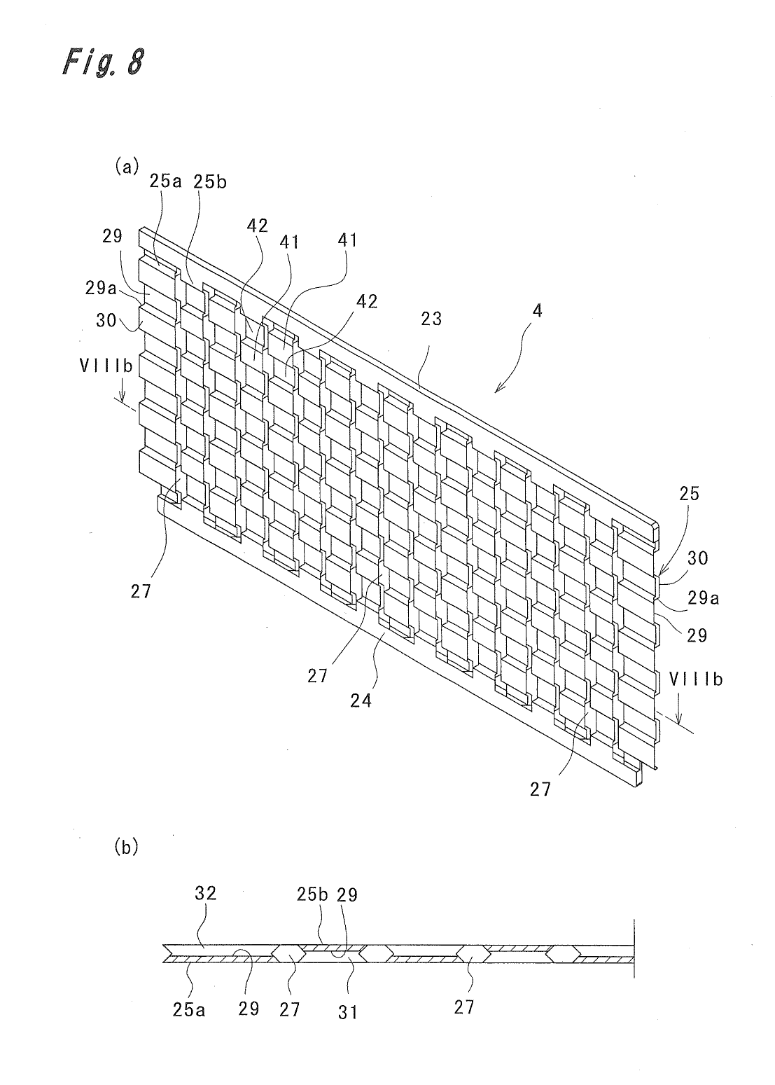

For example, although the first slit 26 and the straight portion 28 are provided in the above-described preferred embodiment, the straight portion 28 may be omitted and the first slit 26 may be formed into the same shape as that of the second slit 27. Namely, as shown in FIGS. 8(a) and 8(b), all of slits 27 may be the same as each other.

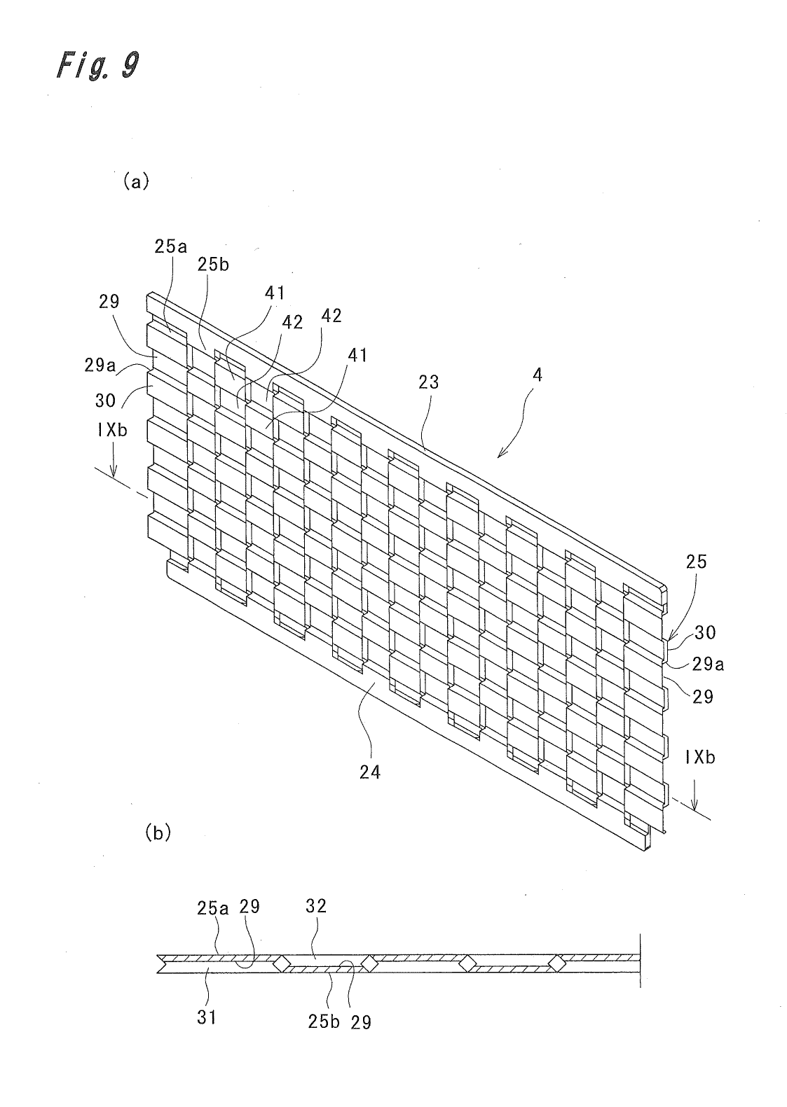

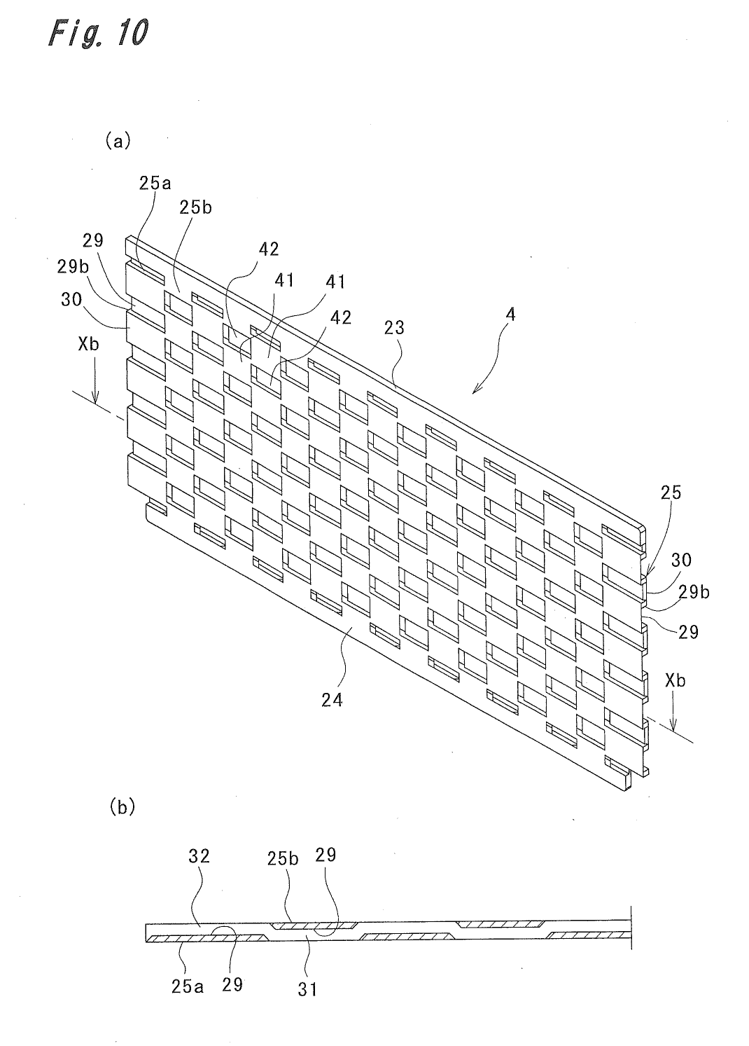

Although the first slit 26 and the second slit 27 are formed and the first corrugated portions 25a and the second corrugated portions 25b are adjacent to each other in the X-direction via the first slit 26 and the second slit 27 in the above-described preferred embodiment, the first corrugated portions 25a and the second corrugated portions 25b may be adjacent to each other without any slits, as shown in FIGS. 9(a), 9(b), 10(a), and 10(b).

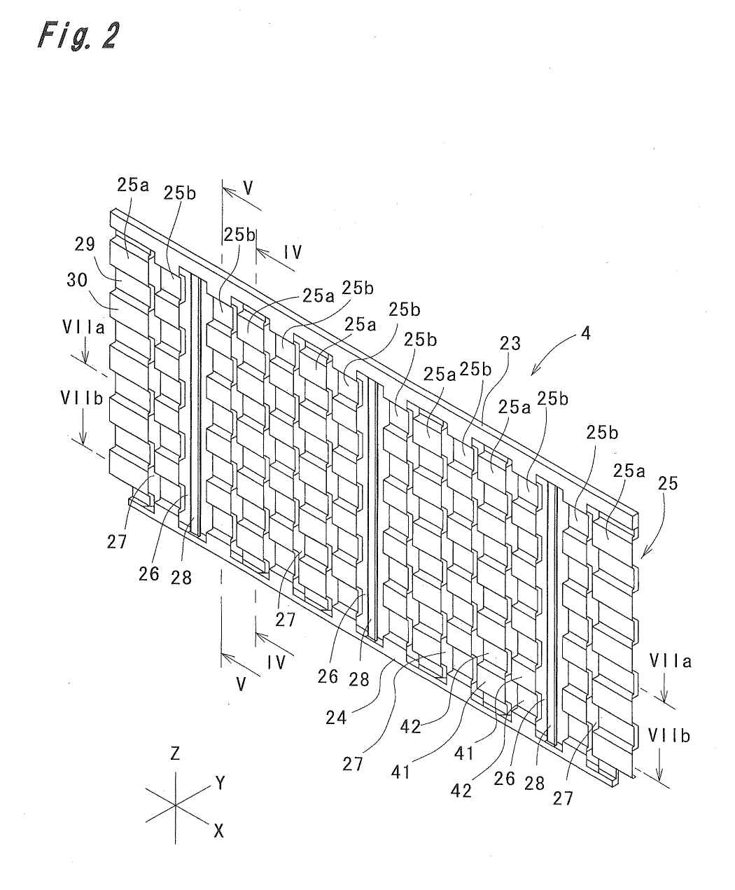

Referring to FIGS. 9(a) and 9(b), the recesses 29 and the projections 30 are continuous to each other in the Z-direction via the slopes 29a, and further, the first corrugated portions 25a and the second corrugated portions 25b adjacent to each other via the slopes 29a are connected to each other in the X-direction, like in FIG. 2.

Moreover, referring to FIGS. 10(a) and 10(b), the recesses 29 and the projections 30 are continuous to each other in the Z-direction via horizontal portions 29b, and further, the first corrugated portions 25a and the second corrugated portions 25b adjacent to each other via the horizontal portions 29b are connected to each other in the X-direction. Both of the preferred embodiments are advantageous because the rigidity of the spacer 4 can be enhanced by the absence of the slit, and further, the flow resistance of the refrigerant flowing in the cooling passages 31 and 32 can be reduced.

In the preferred embodiments, the protrusions 41 and 42 at each of the corrugated portions 25 in the spacer 4 directly abut against or are brought into direct contact with the unit cell 3. However, an inclusion may be interposed between the spacer 4 and each of the unit cells 3 disposed on both sides of the spacer 4, to be positioned between the protrusions 41 and 42 and the unit cell 3. In other words, the protrusions 41 and 42 may indirectly abut against or be brought into indirect contact with the unit cell via the inclusion. Such an inclusion may be a sheet member having an insulating property, but it is not limited to this.

### REFERENCE SIGNS LIST

1 Battery assembly
2 Unit cell
4 Spacer
25a First corrugated portion
25b Second corrugated portion
27 Second slit
29 Recess
30 Projection
31 Cooling passage
32 Cooling passage
33 Chamfer

1. A battery assembly comprising:
a first unit cell and a second unit cell disposed adjacently to each other; and
a spacer interposed between the first unit cell and the second unit cell and adapted to form a cooling passage, through which a cooling medium is allowed to pass;
wherein the spacer comprises:
a first corrugated portion having first protrusions and second protrusions alternately and repeatedly formed in a direction crossing the cooling passage, wherein each of the first protrusion protrudes toward the first unit cell from a center in a thickness direction so as to define a clearance between the second unit cell and the first protrusion whereas each of the second protrusion protrudes toward the second unit cell from the center in the thickness direction so as to define a clearance between the first unit cell and the second protrusion; and
a second corrugated portion arranged adjacently to the first corrugated portion in the direction of the cooling passage and having the first and second protrusions alternately and repeatedly formed in the direction crossing the cooling passage at a phase different from that of the first corrugated portion.

2. The battery assembly according to claim 1, wherein the first protrusions abut against the first unit cell whereas the second protrusions abut against the second unit cell.

3. The battery assembly according to claim 1, wherein the respective first protrusions of the first corrugated portion and the respective second protrusions of the second corrugated portion are aligned in the direction of the cooling passage; and
wherein the respective second protrusions of the first corrugated portion and the respective first protrusions of the second corrugated portion are aligned in the direction of the cooling passage.

4. The battery assembly according to claim 1, wherein the first and second corrugated portions are alternately and repeatedly arranged in the direction of the cooling passage.

5. The battery assembly according to claim 1, wherein the spacer has a slit extending in the direction crossing the cooling passage, and
wherein the first corrugated portion and the second corrugated portion are formed upstream and downstream of the cooling passage in the slit.

6. The battery assembly according to claim 1, wherein the spacer further includes a connecting portion extending in the direction crossing the cooling passage.

7. The battery assembly according to claim 6, wherein the spacer further includes a first bar at one end in the direction crossing the cooling passages in the first and second corrugated portions as well as a second bar at the other end; and
wherein the connecting portion connects the first bar and the second bar to each other.

8. The battery assembly according to claim 1, wherein an upstream end of the cooling passage defined by the first and second protrusions is chamfered at a corner portion.

9. The battery assembly according to claim 1, wherein a downstream end of the cooling passage defined by the first and second protrusions is chamfered at a corner portion.
